(19) United States
(12) Patent Application Publication
(10) Pub. No.: US 2026/0012844 A1
(43) Pub. Date: Jan. 8, 2026

(54) Per-User Automated Dynamic Control of a Microcell Network

(71) Applicant: DISH Wireless L.L.C., Littleton, CO (US)

(72) Inventors: Dhaval Mehta, Aldie, VA (US); Gurpreet Sohi, Parker, CO (US); Sourabh Gupta, Ashburn, VA (US)

(21) Appl. No.: 19/070,719

(22) Filed: Mar. 5, 2025

Related U.S. Application Data
(60) Provisional application No. 63/667,477, filed on Jul. 3, 2024.

(51) Int. Cl. H04W 28/02; H04L 41/16; H04L 41/5009; H04W 24/10

(52) U.S. Cl. CPC H04W 28/0268; H04L 41/16; H04L 41/5009; H04W 24/10; H04W 28/0273

(57) ABSTRACT

Techniques are described for enhancing microcell (e.g., cellular) performance in environments with diverse and dynamic network demands. For example, microcells equipped with distributed units (DUs) and intelligent controllers leverage machine learning (ML) to anticipate and respond to network conditions. Microcells dynamically adjust configurations to maintain quality of service (QOS), prioritize critical UEs based on service level agreements (SLAs), and optimize resource allocation.

### CROSS REFERENCE TO RELATED APPLICATIONS

This application claims priority to U.S. Provisional Patent Application No. 63/667,477, filed on Jul. 3, 2024, the disclosure of which is incorporated by reference in its entirety for all purposes.

### BACKGROUND

Cellular microcells can be used to provide cellular network service to multiple user equipment (UE) operating in a particular environment. Certain locations may tend to have much higher concentrations of UE. These UE may be used by unrelated parties, such as different persons in a mall or stadium or may be operated by a single entity, such as pieces of equipment in a factory or warehouse. Such large numbers of UE operating in a dense environment can create a challenging scenario in order to meet defined Quality of Service (QOS) parameters while operating the cellular network microcells in the environment efficiently.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of an embodiment of multiple cellular microcells installed in an environment.

FIG. 2 illustrates an embodiment of a cellular network core.

FIG. 3 shows a flow diagram of a method for managing quality of service (QOS) in a microcell network comprising a plurality of collocated microcells, according to some embodiments described herein.

FIG. 4 illustrates a block diagram of an embodiment of multiple cellular microcells providing cellular service to multiple user equipment (UE) in an environment.

### DETAILED DESCRIPTION

Cellular microcells can provide cellular network coverage over a smaller region that conventional cellular network base stations. Cellular microcells can be deployed to provide cellular network coverage or improved cellular network coverage for a particular environment, such as within an indoor or in an outdoor environment. Examples include shopping malls, factories, stadiums, casinos, festivals, warehouses, downtown districts, convention centers, shipping yards, etc.

In an environment where multiple cellular microcells are deployed, varying situations may be present and may tend to repeat themselves. For example, referring to a shopping center or mall, particular areas of the mall may tend to be busy at particular times of day and days of the week. For example, a food court may be especially busy at lunchtime. Referring to a factory, a particular production line may tend to be run on weekday mornings and thus may tend to require significantly more cellular network bandwidth during those times but use little bandwidth when the production line is not operating.

As detailed herein, microcells can be improved to intelligently anticipate and respond to changes in conditions. A cellular microcell, which may use 5G New Radio (NR) as its radio access technology (RAT), can have an on-board distributed unit (DU). An on-board distributed unit can provide local control of the microcell's one or more radio units (RUs), including performing scheduling of communications. The processing system that hosts the functionality of the DU can also provide additional functionality by hosting an intelligent controller that can include a machine learning (ML) model that has been trained on how the cellular microcell (and possibly other microcells in the same environment) can be reconfigured to provide more optimized cellular network service. Providing more optimized cellular network service can include: improving performance provided to some or all UE serviced by the cellular microcells; improved performance in meeting QoS parameters specified for particular UE's service level agreements (SLAs); reduced power consumption; reducing interference; and/or providing service to UE that could previously not be serviced by the cellular microcells.

Notably, the use of machine learning by the intelligent controller can allow for the cellular microcells to preemptively adapt to expected conditions of the environment of the cellular microcells. Therefore, in anticipation of one or more particular microcells experiencing a significant increase or decrease in traffic, actions can be taken by the intelligent controller to help ensure that quality of service is maintained for the UE in accordance with QoS parameters defined for the individual UE. As detailed herein, UE can be preemptively switched to receiving service from a different microcell, beamforming can be performed to improve service in particular directions, certain UE can receive preference in scheduling, coordinated multipoint communication can be used, or some combination thereof.

Throughout this document, each cell is referred to as a microcell, or small cell. It should be understood that “microcell” and “small cell” are used interchangeably and can be generalized to include other forms of cells, including macro-cells, femtocells, picocells, small cells, etc. Further, embodiments described herein are not intended to be restricted to cellular microcells or cellular core network functions. The microcells may include other forms of wireless communication nodes, such as Wi-Fi access points, satellite communication nodes, or hybrid systems combining multiple wireless technologies. Similarly, the core network may encompass non-cellular architectures, such as enterprise intranet backbones, private network infrastructures, cloud-based communication systems, or satellite-based networks. For example, in a factory environment, microcells may include Wi-Fi nodes for local area connectivity, while the core network may be a private industrial network utilizing edge computing resources. In another example, a remote outdoor event may deploy satellite communication nodes as microcells, with the core network hosted on a cloud platform. These alternative implementations allow the disclosed techniques to apply broadly across various communication systems, ensuring optimized performance and resource utilization regardless of the underlying network architecture.

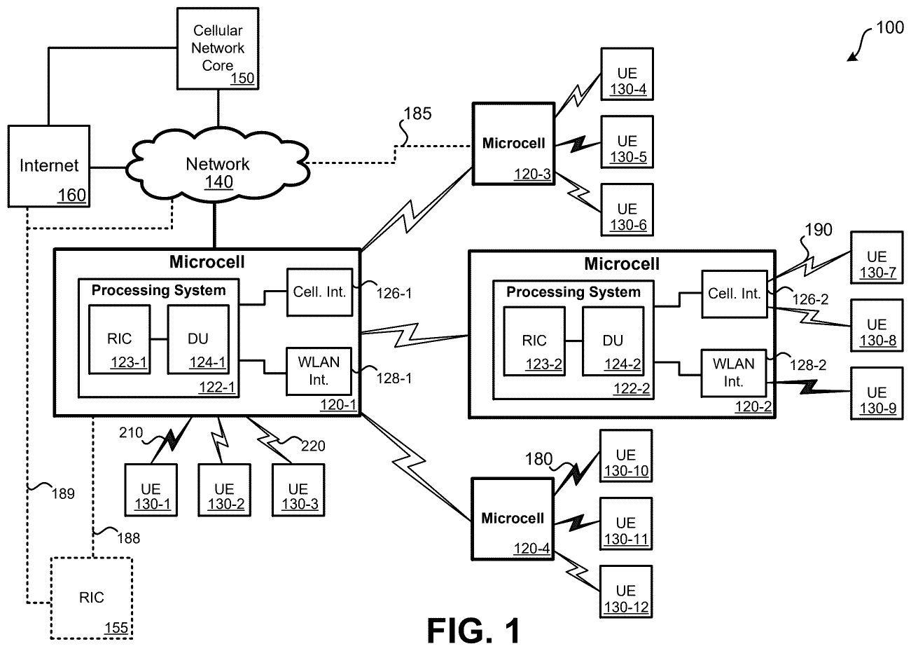

Further detail regarding these and additional embodiments are provided in relation to the figures. FIG. 1 illustrates a block diagram of an embodiment of a multiple cellular microcell system (“system 100”) installed in an environment. System 100 can include: cellular microcells 120 (“microcells 120”); UE 130; network 140; cellular network core 150; and Internet 160. UE can be any form of computerized device that accesses either Internet 160 and/or cellular network core 150, such as smartphones, Internet of Things (IoT) devices, gaming devices, smart factory equipment, smart sensors, smart security equipment, computers, cellular modems, or local access points (e.g., hotspot devices) to which other devices can connect.

In some architectures of system 100, microcell 120-1 serves as a primary microcell through which the other microcells of microcells 120 (e.g., microcells 120-2, 120-3, and 120-4) connect with network 140. Microcell 120-1 serves to communicate with one or more other microcells 120 and interface with network 140. Microcell 120-1 can use a wired connection to network 140. In some embodiments, this wired connection is a high-speed wired connection to an Internet Service Provider's (ISP's) network. For example, an optical fiber connection may be made to network 140. Via network 140, microcell 120-1 can communicate with Internet 160 and cellular network core 150. Cellular network core 150 can be hosted on a public cloud computing service or may be operated on a privately managed server system. All cellular traffic with microcell 120-1 and other microcells of microcell 120 by UE 130 can be routed to cellular network core 150. As needed, cellular network core 150 can access Internet 160, which can occur through one or more firewalls and can be performed by a user plane function (UPF) of cellular network core 150.

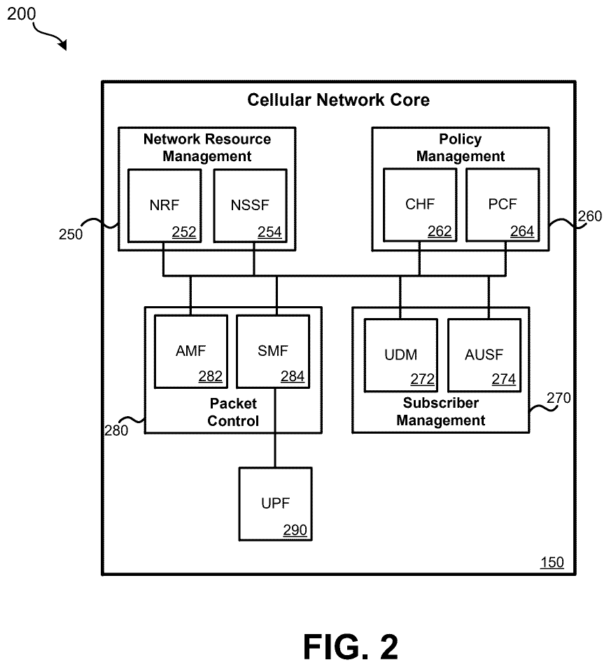

Cellular network core 150 can provide core cellular network functionality. Components of cellular network core 150 can include: network resource management components; policy management components; subscriber management components; and packet control components. Cellular communications with a UE of UE 130 that require accessing the Internet is performed via cellular network core 150. Further detail regarding cellular network core 150 is provided in relation to FIG. 2.

Microcell 120-1 can: 1) communicate directly with UEs via a cellular communication protocol; and 2) communicate with other microcells via the cellular communication protocol. Microcell 120-1 can aggregate communications for all UE with cellular network core 150. In other embodiments, microcell 120-1 may not communicate directly with UEs. As shown, three UE (130-1, 130-2, and 130-3) are in direct communication with primary AP 110 via a cellular communication protocol. The cellular communication protocol can be 5G New Radio (NR). Other cellular communication protocols can be used, such as 4G, 6G, and beyond. Other technologies are also possible, such as wireless local area network (WLAN) technologies, such as WiFi™. From the perspective of UEs 130-1, 130-2, and 130-3, when 5G NR is used as the cellular communication protocol, microcell 120-1 functions as the gNodeB. Therefore, distributed unit (DU) functionality, centralized unit (CU) functionality, and cellular network core access are provided via microcell 120-1. As an example of DU functionality that is provided, scheduler functions are implemented locally to allow for the proper scheduling of communications with UE.

When a UE accesses microcell 120-1 via the cellular communication protocol, the UE's access may be made via a particular cellular network slice. Slicing can allow for particular radio, processing, and bandwidth resources to be reserved for a particular UE or group of UE. As such, different UE can be provided different quality of service (QOS) parameters by assigning the UE to different slices. Accordingly, a UE may be assigned to a slice depending on the importance and functionality of the UE.

Microcell 120-1 can include: processing system 122-1, cellular interface 126-1, and possibly wireless local area network (WLAN) interface 128-1. Microcell 120-1 is shown in direct cellular communication with three UE (130-1, 130-2, 130-3); this is for example only. In other embodiments, fewer or greater numbers of UE may be in direct communication with microcell 120-1.

In this architecture, microcells 120-2 through 120-4 do not have a wired connection to network 140. Rather, microcells 120-2 through 120-4 rely on a cellular communication protocol backhaul link with microcell 120-1 to access network 140. Three additional microcells 120 are shown by way of example; in other examples, fewer or greater numbers of microcells 120 may be present in an environment. The number of microcells used can vary based on the size, load, and interference present within an environment to receive cellular service. For example, a shopping mall may require many microcells to cover multiple stores and floors. As another example, in some architectures, a single microcell may be needed for a relatively open building, such as a warehouse.

UEs wirelessly communicate via a cellular communication protocol (e.g., 5G NR) with microcells 120. From the perspective of UE (130-7, 130-8, 130-9), microcell 120-2 provides gNodeB functionality and access to network 140 (including cellular network core 150 and Internet 160). Microcell 120-2 can receive, transmit, and prioritize communications with UE 130-7, 130-8, and 130-9. UE communications can be prioritized (e.g., according to slices) and transmitted via a backhaul communication channel to microcell 120-1. The backhaul communication channel can use the same cellular communication protocol used for communication with the UE. From the perspective of microcell 120-1, microcells 120-2, 120-3, and 120-4 are treated as individual UE.

In the illustrated architecture of system 100, a hub-and-spoke network topology may be used. In such a topology, each of microcells 120-2, 120-3, and 120-4 has a direct cellular communication protocol backhaul to microcell 120-1. In other embodiments, a mesh or daisy chain topology may be used in which microcells 120 communicate with each other to communicate with microcell 120-1. Regardless of network topology, each of microcells 120 may be physically connected only to power with all communications performed wirelessly.

In FIG. 1, a total of four microcells 120 are illustrated. Fewer or greater numbers of microcells 120 may be present in other embodiments. As shown, UE 130-4, 130-5 and 130-6 communicate with microcells 120-3. UE may move and thus may shift with which microcell in the environment that communication is performed. The number of UE communicating with each of microcells 120 can be greater or fewer than three.

System 100 can have alternative architectures. Rather than having other cellular microcells communicate with network 140 through microcell 120-1, at least some of microcell 120 can communicate directly with network 140. For example, as shown by connection 185, microcell 120-3 may communicate directly with network 140 (e.g., via a wired connection) and, thus, backhaul communications between microcell 120-3 and microcell 120-1 may not be necessary (or may serve as a backup connection). While not illustrated in FIG. 1, microcells 120-2 and 120-4 can also have direct communication (e.g., wired connections) with network 140.

System 200 can also provide WLAN connectivity to UE. WLAN connectivity can be provided to UE via a Wi-Fi family protocol, which is based on the IEEE 802.11 family of standards. Therefore, a UE can use a WLAN connection, cellular connection, or both to communicate with cellular microcells 120.

WLAN communications performed by UE with a cellular microcell of cellular microcells 120 are also transmitted to cellular microcell 120-1 via cellular backhaul communication. Cellular microcells 120 can use a defined prioritization scheme to define how WLAN communications are prioritized in relation to cellular communications. For example, WLAN communications may be effectively treated as a slice in that particular QoS parameters are met, which may be higher or lower than some or all cellular slices.

Once WLAN communications are transmitted by other microcells of microcells 120 to microcell 120-1, microcell 120-1 may translate the communications to an appropriate protocol (e.g., TCP/IP) and transmit to network 140. WLAN communications can be routed directly to Internet 160 by microcell 120-1 via network 140. In contrast, cellular communications by UE 130 via microcells 120 are routed to cellular network core 150, which processes such communications and handles communications, as needed, with Internet 160. In other embodiments, WLAN communications involving the Internet can also be routed to cellular network core 150, which can then access Internet 160. IMS voice communications over the WLAN can be routed to cellular network core 150.

As shown in FIG. 1, some UE are using WLAN communications to access Internet 160, as shown by WLAN communications 180. Other UE are using cellular communications to access Internet 160 through cellular network core 150, as shown by cellular communications 190. UE may also use both forms of wireless communication. For example, a UE may be executing multiple applications: a first application may use cellular communication in order to ensure security and/or that particular QoS parameters are met (e.g., latency, uplink bandwidth, downlink bandwidth, jitter), and a second application may use WLAN communication since security and/or QoS are not as essential to the functioning of the second application.

As shown in FIG. 1, microcell 120-2 may have a WLAN interface 128-2. Microcell 120-1 may have WLAN interface 128-1. In some embodiments, this interface is not present and microcell 120-1 cannot perform direct WLAN communications with UE.

On board microcell 120-1 is processing system 122-1. Processing system 122-1 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random-access memory (RAM), flash memory, a hard disk drive (HDD), or a solid-state drive (SSD).

Processing system 122-2 can perform the functionality of distributed unit (DU) 124-1. One of the primary functions of a DU is to perform scheduling of cellular communications with UE that are in communication with cellular interface 126-1. Processing system 122-2 has additional processing resources that are available in addition to that used to perform the functionality of DU 124-1. As such, processing system 122-2 can also perform the functions of a radio access network (RAN) intelligent controller (RIC) 123-1. RIC 123-1 can alter the functionality of microcell 120-1 and, possibly of other cellular microcells 120 within the environment. In other embodiments, separate processing systems may be used for RIC 123-1 and DU 124-1.

Within RIC 123-1, one or more ML models may be trained, executed, or both trained then executed. An ML model may be created using a set of training data that has been mapped to a correct or desired outcome. For example, a set of inputs that defines a network condition can be mapped to a particular action that is to be taken in response. The ML model may be created based on data no specific to the environment of system 100. For example, a cellular network operator may create various ML models that are expected to be useful for particular types of environments, such as shopping centers, warehouses, factories, festivals, etc. These models may then serve as a baseline that can be updated based on usage of the microcells. Alternatively, an ML model can be fully trained at microcell 120-1. This arrangement has a benefit of being trained exclusively on situations that specifically within the environment of system 100.

In some embodiments, the ML models employed include neural networks. Neural networks may be created using either supervised or unsupervised learning. As an example of supervised learning, the neural network may be trained by providing a group of inputs that correspond to truth-tagged or desired outputs. The neural network can then be used to create outputs based on its training. The ML model inputs can include one or more characteristics selected from the following: number of UE in communication with the microcell; amount of uplink data being transmitted by the UE to the microcell; amount of downlink data being transmitted by the microcell to the UE; time of day; day of week; QoS parameters of the UE; slices to which the UE are assigned; and applications being executed on the UE. Outputs of the ML model can include changes to: UE to microsite assignments; changes to scheduling as performed by the DU; beamforming or beam steering data; requests to power up or power down microcells; coordinated multipoint requests, or some combination thereof.

Microcell 120-1 may host RIC 123-1, which can update functionality of each of microcells 120 within the environment. Alternatively, some or all of microcells 120 may host a RIC, such as RIC 123-2, which is hosted by processing system 122-2 along with DU 124-2 of microcell 120-2. In such embodiments, the same one or more MLs may be hosted by each of RICs 123 of microcells 120 or the MLs may vary by microcell. That is, each ML may be trained specifically on data obtained at the specific microcell where the ML is to be implemented.

In other embodiments, a RIC may be hosted remotely from microcells 120. RIC 155 may be hosted by a computing system that is local to the environment in which microcells 120 are present. For example, connection 188 (which can be wired or wireless) may be used to connect a computing device hosting RIC 155 with microcell 120-1. In such embodiments, RIC 155 can access data from microcells 120 to understand the conditions at each microcell. RIC 155 may be accessible via network 140 or internet 160, as shown by connection 189. In some embodiments, RIC 155 may be hosted by a cloud computing platform, such as on the cloud computing platform where cellular network core 150 may be hosted.

In general, although some embodiments herein describe the RIC as being implemented within the microcells, embodiments can additionally or alternatively implement the RIC in more centralized locations, such as within a local server, an edge computing device, or a cloud-based platform. For example, in a shopping mall or stadium, a centralized RIC may coordinate multiple microcells across the entire venue, enabling seamless optimization of network resources and coverage. Alternatively, in distributed architectures, the RIC may be implemented on a hybrid basis, with non-real-time (non-RT) RIC functionality hosted centrally (e.g., in the cloud) for tasks like machine learning (ML) model training and policy management, and real-time (RT) RIC functionality implemented locally within microcells for time-sensitive operations, such as beamforming and scheduling. This division of RIC functionality helps to ensure that both latency-critical and computationally intensive tasks are handled efficiently while maintaining scalability and adaptability to various network environments.

FIG. 2 illustrates an exemplary cellular network core 150. Core 150 can be physically distributed across data centers or located at a central national data center (NDC) and can perform various core functions of the cellular network. Core 150 can include: network resource management components 250; policy management components 260; subscriber management components 270; and packet control components 280. Individual components may communicate via a bus, thus allowing various components of core 150 to communicate with each other directly. Core 150 is simplified to show some key components. Implementations can involve additional components.

Network resource management components 250 can include: Network Repository Function (NRF) 252 and Network Slice Selection Function (NSSF) 254. NRF 252 can allow 5G network functions (NFs) to register and discover each other via a standards-based application programming interface (API). NSSF 254 can be used by AMF 282 to assist with the selection of a network slice that will serve a particular UE (e.g., UEs 130 of FIG. 1).

Policy management components 260 can include: Charging Function (CHF) 262 and Policy Control Function (PCF) 264. CHF 262 allows charging services to be offered to authorized network functions. Converged online and offline charging can be supported. PCF 264 allows for policy control functions and the related 5G signaling interfaces to be supported.

Subscriber management components 270 can include: Unified Data Management (UDM) 272 and Authentication Server Function (AUSF) 274. UDM 272 can allow for generation of authentication vectors, user identification handling, NF registration management, and retrieval of UE individual subscription data for slice selection. AUSF 274 performs authentication with UEs.

Packet control components 280 can include: Access and Mobility Management Function (AMF) 282 and Session Management Function (SMF) 284. AMF 282 can receive connection- and session-related information from UEs and is responsible for handling connection and mobility management tasks. SMF 284 is responsible for interacting with the decoupled data plane, creating updating and removing Protocol Data Unit (PDU) sessions, and managing session context with the User Plane Function (UPF).

In some embodiments, coordination with core network functions, such as the NRF, PCF, and AMF, is performed through standardized APIs. These interactions allow microcells to request updated resource allocations, slice adjustments, or policy changes, for example, based on detected dynamic QoS degradations.

User plane function (UPF) 290 can be responsible for packet routing and forwarding, packet inspection, quality of service (QOS) handling, and external PDU sessions for interconnecting with a Data Network (DN) (e.g., the Internet). For example, when a UE of UE 130 attempts to communicate with the Internet via cellular communication, the request may be routed through UPF 290.

In embodiments described herein, per-user or per-user-group (e.g., user category) tracking and improvement of quality of service (QOS) is provided. In some cases, the QoS is provided based on predefined service level agreements (SLAs). In existing Open Radio Access Network (ORAN) architectures, a particular user equipment (UE) is typically identified using different identifiers across various nodes due to the heterogeneous nature of the network components and the protocols they employ. Each node within the network—such as microcells, distributed units (DUs), centralized units (CUs), and core network functions—may assign and use its own local identifier for the same UE. This fragmentation arises because each component is designed to perform specific functions and may operate using different layers of the communication protocol stack.

For example, at the radio interface level within the microcells (e.g., microcells 120 in FIG. 1), the UE might be associated with a temporary identifier used for scheduling and resource allocation by the DU 124. At the core network level, the same UE is identified using permanent identifiers like the International Mobile Subscriber Identity (IMSI) or the Subscriber Permanent Identifier (SUPI). Additionally, when the UE moves between microcells or connects through different slices of the network, it may be assigned different identifiers corresponding to the specific network slice selection function (NSSF) 254.

This lack of a unified identifier can complicate consistent tracking of the UE across the network. For example, without a common identifier, it can be challenging to correlate data and performance metrics collected at different nodes for the same UE, which can hinder the ability to monitor and manage the UE's quality of service (QOS) effectively. As a result, implementing per-user or per-user-group QoS management based on predefined service level agreements (SLAs) becomes difficult, as the network cannot accurately enforce policies or make informed decisions to adjust resources in real time.

Moreover, the inconsistency in UE identification can impact advanced network functions such as intelligent congestion management and predictive resource allocation. As described herein, some embodiments use AI/ML models hosted on the RAN Intelligent Controller (RIC) 123 to recognize patterns and trends of users served within the environment. Such models rely on data that can be correlated, compared, etc. to recognize such patterns and trends. If the UE cannot be consistently identified across nodes, the AI/ML models may not accurately detect congestion causes or predict user behavior, reducing their effectiveness in optimizing network performance.

Embodiments introduce a common identifier for each UE across the entire network to support consistent tracking of UEs across nodes. The common identifier can be referred to herein as a unified network identifier (UNI). The UNI enables seamless coordination among microcells, DUs, CUs, and core network functions, facilitating real-time data correlation and more effective QoS management. Consequently, the network can intelligently adapt to changing conditions, such as adjusting microcell configurations for beam pointing and shaping or reallocating resources based on user priority as defined in their SLAs.

The UNI can be generated in any reasonable manner such that the resulting UNI facilitates a UE to be used consistently across multiple different types of nodes in an Open Radio Access Network (ORAN). In some embodiments, the UNI is generated by utilizing standardized permanent identifiers such as the International Mobile Subscriber Identity (IMSI) or the Subscription Permanent Identifier (SUPI). By using the IMSI or SUPI as the UNI, nodes can consistently recognize and manage the same UE throughout the network. However, directly using these identifiers may raise privacy concerns, as they can expose the subscriber's identity if not properly secured.

In other embodiments, the UNI is generated by implementing a Subscription Concealed Identifier (SUCI), which is a privacy-preserving identifier derived from the SUPI using encryption methods. The SUCI allows the network to identify the UE without exposing permanent identifiers, enhancing security while maintaining consistent identification across nodes. Alternatively, the UNI can be assigned as a Globally Unique Temporary Identifier (GUTI) coordinated across nodes. By synchronizing GUTI assignments, the UNI serves as a temporary identifier recognizable throughout the network, facilitating consistent UE tracking.

In some embodiments, the UNI is generated by combining multiple identifiers into a composite identifier. This composite can be created by merging standardized identifiers such as the IMSI, device serial numbers, or MAC addresses, and then hashing them to produce a unique and secure UNI used across all nodes. This approach helps to ensure privacy by not exposing the original identifiers. For example, the UNI can be generated by applying secure hash algorithms on permanent identifiers. Secure hash functions are applied to permanent identifiers like the IMSI to generate a non-reversible hashed UNI. This hashed identifier is consistent across nodes and protects the original identifier from exposure, balancing consistency and privacy.

Another approach involves generating the UNI through a network-assigned unique identifier at registration. Upon initial registration, the network assigns a unique identifier to the UE, which is stored in a central database accessible by all nodes. This identifier remains consistent during the UE's session and facilitates tracking and quality of service (QOS) management.

In certain embodiments, the UNI is generated by extending Network Slice Selection Function (NSSF) identifiers to serve as common identifiers across nodes. Since UEs may be assigned to specific network slices based on their QoS requirements, using NSSF identifiers aligns UE identification with the network slicing architecture and QoS management policies.

The UNI can also be generated by employing AI/ML-based identification methods. AI/ML models within the Radio Access Network Intelligent Controller (RIC) analyze patterns of UE behavior and network usage to assign identifiers based on observed characteristics. This method leverages AI/ML to infer consistent identification without relying solely on predefined identifiers.

In other embodiments, the UNI is established using a Public Key Infrastructure (PKI) and digital certificates. UEs are issued digital certificates containing public keys that serve as unique identifiers. Nodes verify these certificates to consistently identify UEs, enhancing security through cryptographic means and integrating with existing authentication procedures. Another option is to implement a centralized identifier mapping function within the network core, such as the Network Repository Function (NRF). This function maintains a correspondence between local identifiers used by individual nodes and the UNI. Nodes query this function to resolve local identifiers, enabling consistent UE identification.

Each microcell, such as microcells 120 in FIG. 1, includes a processing system (e.g., processing system 122-1 in microcell 120-1) that hosts an onboard Distributed Unit (DU) 124 and a Radio Access Network (RAN) Intelligent Controller (RIC) 123. The DU manages local control of the microcell's Radio Units (RUs), performing functions like scheduling communications with UE. The RIC hosts AI/ML models that have been trained to recognize patterns and trends of users served within the environment, enabling the microcells to intelligently anticipate and respond to changes in network conditions.

The AI/ML models analyze data collected from UE, using the common identifier to track individual users or user groups consistently across the network. This analysis assists in determining causes of congestion, such as an unexpected influx of high-bandwidth users in a specific area, and in identifying proactive solutions to mitigate such congestion. The intelligent controller can send recommendations to the RAN or to a third-party RIC to influence the RAN behavior for those users, adjusting parameters like beamforming patterns, scheduling priorities, and handover decisions.

For instance, in response to detected congestion, the network can determine optimal adjustments to the communications provided by each of the multiple microcells to improve QoS. Adjustments may include dynamically configuring microcells to perform beam pointing and beam shaping to direct radio signals toward areas with higher user density, thereby enhancing signal strength and reducing interference. Traffic shaping techniques can be applied to prioritize network resources for users with higher QoS requirements as defined in their SLAs.

Consider an example scenario in a shopping mall environment depicted in FIG. 1, where multiple microcells 120 provide cellular network coverage. Suppose a department store within the mall aims to ensure that its customers maintain a high QoS as they approach and move within the store. As customers carrying UEs approach the store from any direction, the AI/ML models hosted on the microcells recognize the pattern of increasing user density. The RIC leverages this information to dynamically configure one or more microcells to adjust their beamforming parameters, focusing signal strength toward these users to maintain high QoS and mitigate interference.

For example, multiple cellular microcells 120 are strategically installed throughout the mall to provide comprehensive cellular network coverage. Each microcell, such as microcell 120-1, includes a processing system 122-1 that hosts both the Distributed Unit (DU) 124-1 and the Radio Access Network (RAN) Intelligent Controller (RIC) 123-1. The DU manages local control of the microcell's Radio Units (RUs), including scheduling communications with User Equipment (UE). The RIC hosts advanced AI/ML models trained to recognize patterns of user behavior and network conditions within the environment.

As customers carrying UEs approach the department store from any direction, their devices are consistently tracked across the network using a Unified Network Identifier (UNI), which combines standardized identifiers like the International Mobile Subscriber Identity (IMSI) and the Subscription Permanent Identifier (SUPI). This consistent identification allows for accurate aggregation of data on user density and movement patterns. The AI/ML models running on the RICs analyze real-time data from the microcells to detect patterns of increasing user density near the department store. These models consider factors such as time of day, day of the week, and historical data indicating that, for example, the store experiences higher foot traffic during certain hours. By learning from these patterns, the models can predict impending congestion before it occurs.

Upon recognizing the surge in user density, the RIC leverages this information to dynamically adjust the network configuration. Specifically, it sends instructions to the DU to modify the beamforming parameters of the microcells' RUs. Beamforming involves adjusting the amplitude and phase of the signals transmitted by the antenna elements to direct the radio energy toward a specific area where increased user density is detected.

For instance, microcell 120-2 and microcell 120-3, which are in proximity to the department store, can be configured to steer their beams towards the store's entrance and interior spaces. This targeted beamforming enhances signal strength and quality for the customers within the store, ensuring they experience high Quality of Service (QOS) as they move around. It also helps in mitigating interference by reducing signal overlap with adjacent areas where high coverage is not required at that moment.

Additionally, the RIC may coordinate beamforming adjustments among multiple microcells to manage the overall network performance. For example, if microcell 120-3 is experiencing high load due to the increased number of UEs, the RIC might direct some UEs to be served by neighboring microcell 120-2 by adjusting their respective beam patterns and scheduling priorities. This dynamic load balancing ensures that no single microcell becomes a bottleneck, maintaining optimal network performance.

In another scenario, the department store utilizes various devices such as point-of-sale payment systems requiring low latency and high reliability, tablets carried by salespeople necessitating moderate bandwidth, and customers' smartphones with varying QoS needs. The microcells can be dynamically configured to provide the most appropriate QoS for each category of user by adjusting scheduling priorities and resource allocation based on their SLAs. For example, the RIC may instruct the DU to prioritize uplink and downlink resources for payment systems to ensure transaction reliability, while allocating sufficient resources to sales tablets and managing the remaining capacity for customer smartphones.

For example, each microcell in the store, such as microcell 120-3, is equipped with a processing system hosting the DU 124-3 and the RIC 123-3. The devices are identified and tracked using the Unified Network Identifier (UNI), allowing consistent recognition across the network and enabling per-device or per-category QoS management. The RIC utilizes AI/ML models to analyze network usage patterns and the specific requirements of each device category. It monitors factors such as the number of active devices, their data transmission rates, and the QoS parameters specified in their SLAs.

For instance, the POS systems might be identified as high-priority devices due to their critical role in business operations. Based on this analysis, the RIC dynamically adjusts scheduling priorities and resource allocations within the DU. For the POS systems, the RIC instructs the DU to prioritize uplink and downlink resources to guarantee low latency and high reliability. This may involve reserving specific time slots or frequency resources exclusively for POS communications, ensuring that payment transactions are processed without delay. For the salespeople's tablets, the RIC allocates sufficient bandwidth to support applications like inventory management and customer engagement tools. While these devices do not require as stringent latency requirements as the POS systems, they still need reliable connectivity. The RIC balances their resource allocations to maintain their operational effectiveness without impeding the higher-priority POS systems. Customers' smartphones present a diverse set of QoS needs, ranging from simple messaging to high-definition video streaming. The RIC manages the remaining network capacity to accommodate these varying demands. It may implement traffic shaping policies that optimize bandwidth usage, such as limiting the maximum throughput for non-critical applications during peak usage times to ensure fair distribution of resources.

Furthermore, the RIC can utilize beamforming techniques to enhance connectivity for devices based on their locations and priorities. For example, if a cluster of customers is congregating in a specific area of the store, the microcells can adjust their beam patterns to improve signal quality in that zone. Conversely, resources can be shifted away from areas with low device activity to maximize overall network efficiency. The AI/ML models continuously learn and adapt to changes in device usage patterns and network conditions. They can predict busy periods, such as sales events or holidays, and preemptively adjust network configurations to handle the anticipated increase in device activity. This proactive approach ensures that all device categories receive the appropriate QoS as defined in their SLAs, enhancing user experience and operational efficiency.

Another example scenario can occur in a modern hospital, where reliable and prioritized communication is crucial for patient care and operational efficiency. Multiple microcells, such as microcells 120 in FIG. 1, are deployed throughout the hospital to provide comprehensive cellular network coverage. Each microcell includes a processing system hosting a DU and a RIC. The hospital environment involves various categories of devices: critical medical equipment like patient monitors requiring ultra-low latency and high reliability, doctors' tablets needing secure and responsive access to patient records, and visitors' smartphones with standard connectivity needs.

Using UNIs, each device is consistently identified across the network, allowing for precise tracking and QoS management. The AI/ML models running on the RICs analyze real-time network data and device requirements. For critical medical equipment, the RIC assigns the highest priority, instructing the DU to allocate dedicated resources and prioritize uplink and downlink scheduling to ensure continuous, uninterrupted data transmission. Beamforming techniques are utilized to enhance signal strength specifically in areas with critical equipment, such as intensive care units, by adjusting the amplitude and phase of signals transmitted by the antenna elements. Doctors' tablets are assigned a high priority with secure communication channels. The RIC configures the microcells to provide encrypted connections and sufficient bandwidth for accessing large medical imaging files and patient records. Traffic shaping policies are applied to guarantee that these devices maintain the necessary QoS without being affected by network congestion. For visitors' smartphones, which require standard connectivity, the RIC manages the remaining network capacity, ensuring that critical medical devices and staff equipment are not impacted by visitor usage.

The AI/ML models continuously learn from the network's performance and adapt to changing conditions, such as increased visitor numbers during visiting hours or sudden surges in data from medical devices in emergency situations. By proactively adjusting network configurations, the system maintains the QoS as defined in the SLAs for each device category, ensuring patient safety and efficient hospital operations.

Another example scenario can occur in an advanced manufacturing facility, where multiple microcells are installed to provide robust cellular network coverage essential for the operation of autonomous robots, industrial sensors, and communication devices used by maintenance staff. The autonomous robots require real-time communication with control systems, demanding ultra-low latency and high reliability to function correctly and safely. Industrial sensors distributed across the factory floor need consistent connectivity to transmit data for monitoring equipment status and production metrics. Maintenance staff use handheld devices and tablets requiring moderate bandwidth and reliable connectivity.

Each device is assigned a UNI for consistent tracking and QoS management across the network. The AI/ML models in the RICs analyze device requirements and network conditions, prioritizing resources accordingly. For autonomous robots, the RIC instructs the DUs to allocate priority resources, ensuring minimal latency and high data throughput. Beamforming is employed to direct strong signals toward the robots' operating zones, enhancing communication reliability and reducing the risk of interruptions. Industrial sensors are given priority for reliable data transmission but with less stringent latency requirements. The RIC configures the microcells to provide sufficient bandwidth and stable connections for these sensors, applying traffic shaping where necessary to prevent data bottlenecks. Maintenance staff devices are allocated resources that ensure they have the connectivity needed to perform diagnostics, access manuals, and communicate with other staff without impeding the critical operations of robots and sensors.

The AI/ML models predict shifts in network demand based on production schedules and historical data. For example, during peak production times, when robot activity is highest, the system preemptively adjusts network configurations to accommodate increased data flow. In the event of a network anomaly or unexpected surge in data traffic, the AI/ML models detect the issue and dynamically reallocate resources or adjust beamforming parameters to maintain QoS for critical devices. This ensures the factory operates smoothly, with minimal downtime and optimal efficiency.

Another scenario can occur in a large outdoor music festival, where multiple microcells are deployed to cover the expansive area, providing network connectivity for attendees, performers, and event staff. The attendees primarily use their smartphones for messaging, social media, and streaming services. Performers and production crew require reliable, low-latency connections for live broadcasting, stage coordination, and control of lighting and special effects. Event security and emergency services need priority communication channels for safety operations.

Using UNIs, every user's device is consistently tracked across the network. The AI/ML models running on the RICs analyze crowd movement patterns, network usage, and device categories. For performers and production crew, the RIC prioritizes network resources by instructing the DUs to allocate dedicated channels with high bandwidth and low latency, essential for live broadcasts and coordinated stage operations. Beamforming techniques are applied to strengthen signals at the main stage and production areas, ensuring uninterrupted connectivity.

For event security and emergency services, the RIC configures the microcells to provide secure and prioritized communication channels. This may involve reserving specific frequency bands exclusively for these services, employing encryption, and ensuring minimal interference. Traffic shaping policies are implemented to guarantee that these critical communications remain unaffected by the high network demand from attendees. Attendees' smartphones are managed by balancing network capacity and applying QoS policies that provide satisfactory service without compromising critical operations. The AI/ML models predict areas of high network congestion based on crowd density, such as near popular stages or food courts. The system dynamically adjusts beamforming patterns and resource allocations to mitigate potential bottlenecks, enhancing user experience.

Additionally, the AI/ML models can detect sudden changes in network patterns that may indicate emergencies, such as rapid shifts in user locations or spikes in communication from certain areas. In such cases, the system can adapt by reallocating resources to support emergency services and facilitate crowd safety measures. By intelligently managing the network based on user categories and real-time data, the system ensures a successful event with efficient communications for all stakeholders.

As described above, embodiments use AI/ML for pattern recognition and trend analysis. Implementing the AI/ML components for per-user and per-user-category features of the invention involves several reasonable options that leverage different AI/ML architectures and methodologies to enhance network performance and QoS management. Some implementations utilize centralized AI/ML models hosted on the RICs within the microcells. These models analyze aggregated data from all connected UEs, using the UNI to consistently track users across the network. The centralized models can employ supervised learning algorithms, trained on historical network data tagged with performance metrics and corresponding network configurations. This training enables the models to predict optimal network adjustments for varying user patterns and behaviors.

Some implementations use distributed AI/ML models at the microcell level, where each microcell hosts its own AI/ML instance within its processing system. These models focus on local network conditions, analyzing data specific to their coverage area. By using unsupervised learning techniques, such as clustering algorithms, the models can identify patterns and anomalies in user behavior without predefined labels. This approach allows microcells to autonomously adjust parameters like beamforming and scheduling priorities in response to real-time conditions, enhancing QoS for individual users and user groups.

Some implementations use reinforcement learning for the AI/ML. Models learn optimal network configurations through trial and error, receiving feedback in the form of rewards based on achieved QoS levels and network efficiency. Over time, the reinforcement learning models converge toward strategies that maximize overall network performance while adhering to the SLA requirements of different user categories. Such implementations are particularly effective in dynamic environments where user behavior is unpredictable.

Some implementations use federated learning to address privacy concerns associated with centralized data processing. AI/ML models are trained locally at each microcell using local data, and only the model updates are shared with a central server or other microcells. This allows the network to benefit from collective learning across multiple microcells without transmitting sensitive user data, maintaining compliance with privacy regulations.

For per-user QoS adaptation, AI/ML models can analyze individual user profiles, usage patterns, and SLA specifications to tailor network resources accordingly. Techniques like decision trees and support vector machines can be used to classify users into different priority levels, enabling the network to allocate resources in a way that meets individual QoS requirements. By continuously monitoring user behavior, the models can adjust allocations in real time, ensuring that high-priority users receive the necessary bandwidth and low latency.

Embodiments can use predictive analytics, where AI/ML models utilize time series forecasting methods to anticipate network congestion and user demand patterns. By predicting potential hotspots and periods of high usage, the network can proactively adjust configurations, such as preemptively reallocating resources or adjusting beamforming directions. This helps in maintaining QoS during peak times and prevents degradation of service.

Additionally, AI/ML can be implemented to optimize beamforming and resource allocation by using deep learning models, such as neural networks, that learn complex patterns in the data. These models can process high-dimensional inputs, including user location, signal strengths, and interference levels, to calculate the optimal beamforming vectors and resource block assignments. This results in improved signal quality and efficient use of the network spectrum.

Some implementations integrate AI/ML models with policy control functions within the network core, such as the Policy Control Function (PCF). By doing so, the AI/ML models can make decisions that are aligned with the network's policies and regulatory requirements. The models can recommend policy updates or exceptions in real time to accommodate unique situations, such as emergency services requiring immediate high-priority access.

Some embodiments combine multiple AI/ML techniques. For example, using a hybrid model that incorporates both supervised and unsupervised learning allows the network to benefit from predefined knowledge while still discovering new patterns in user behavior.

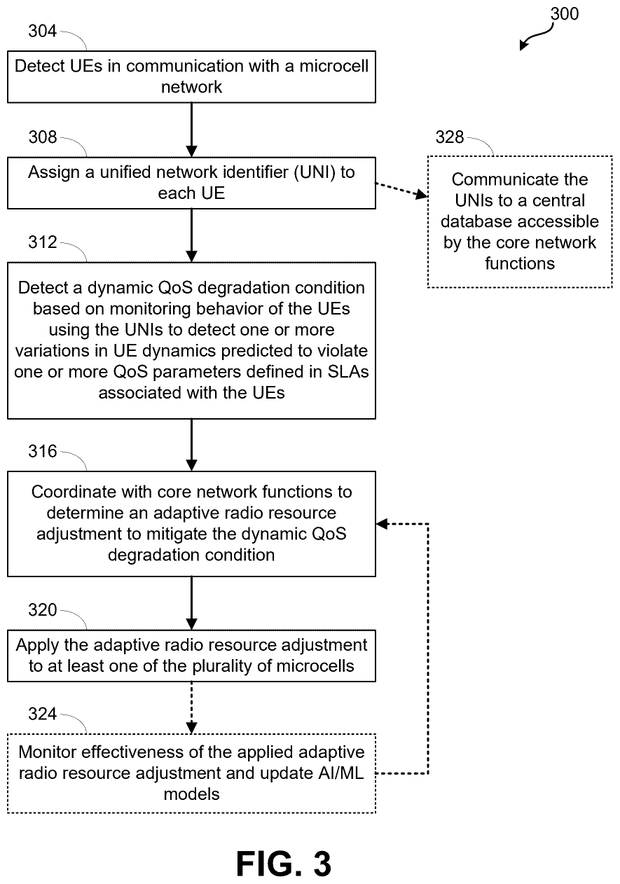

FIG. 3 shows a flow diagram of a method 300 for managing quality of service (QOS) in a microcell network comprising a plurality of collocated microcells, according to some embodiments described herein. Embodiments begin at stage 304 by detecting a plurality of user equipment (UEs) in communication with the microcell network. This detection can be performed by the microcells themselves using their distributed units (DUs), by Radio Access Network (RAN) Intelligent Controllers (RICs) hosted within the microcells, or in any other suitable manner. The detection can involve monitoring active UE connections, signal strengths, communication protocols such as 5G New Radio (NR), and other parameters such as UE density within a specific region or microcell. The DUs within the microcells can track the number of UEs communicating with each microcell, while the RICs can aggregate this data to form a comprehensive view of the network state.

In stage 308, embodiments can assign a unified network identifier (UNI) to each of the plurality of UEs. The UNI can be generated using a variety of methods, such as deriving it from standardized identifiers like the International Mobile Subscriber Identity (IMSI) or the Subscription Permanent Identifier (SUPI). For enhanced privacy, the UNI may instead be based on a Subscription Concealed Identifier (SUCI) generated using encryption techniques. Alternatively, the UNI may be assigned as a Globally Unique Temporary Identifier (GUTI) synchronized across the microcell network, or it may be generated using a hashing mechanism applied to permanent identifiers. Once assigned, the UNIs allow consistent tracking of UEs across the network, enabling seamless coordination and data correlation between microcells, DUs, and core network functions.

In stage 312, embodiments can detect a dynamic QoS degradation condition by monitoring the behavior of the plurality of UEs using the assigned UNIs. As used herein, dynamic QoS degradation refers to real-time changes in network conditions, such as increased UE density, unexpected data surges, or environmental factors, that result in a deviation from SLA-defined QoS parameters. These conditions can be detected using AI/ML models analyzing metrics like SINR, throughput, and latency. The detection at stage 312 can involve analyzing real-time data to identify one or more variations in UE dynamics, such as changes in UE density, movement patterns, or data usage, that are predicted to violate QoS parameters defined in service level agreements (SLAs) associated with the UEs. AI/ML models hosted on the RICs play a key role in this detection process, leveraging supervised or unsupervised learning techniques to recognize patterns or anomalies in network conditions. For example, the models may identify a surge in UE density near a specific microcell, signaling potential congestion and impending QoS degradation. The detection process can operate at both individual UE levels and UE category levels, allowing for granular analysis of network behavior.

In stage 316, embodiments can coordinate with core network functions to determine an adaptive radio resource adjustment to mitigate the detected dynamic QoS degradation condition. This coordination involves communication between the RICs and core network components such as the Network Repository Function (NRF), Network Slice Selection Function (NSSF), Policy Control Function (PCF), and Access and Mobility Management Function (AMF). For instance, the NSSF may assist in reallocating UEs to different network slices to balance the load, while the PCF can define updated QoS policies to prioritize critical UEs or UE categories. The RICs may also request additional network resources or adjustments to scheduling priorities to address the specific conditions causing the QoS degradation.

In stage 320, embodiments can apply the adaptive radio resource adjustment to at least one of the plurality of microcells. This adjustment may involve a combination of techniques such as modifying beamforming or beam steering parameters to direct radio frequency energy toward areas of higher UE density, adjusting transmission power levels to expand or shrink the coverage area of specific microcells, or reallocating communication slots and frequency blocks to prioritize UEs with higher QoS requirements as defined in their SLAs. For example, a microcell experiencing high traffic may dynamically adjust its beamforming to offload UEs to neighboring microcells or prioritize critical UEs by providing them with a greater share of available bandwidth. In some implementations, when applying adaptive radio resource adjustments, the microcells dynamically reallocate bandwidth, adjust physical resource blocks, and/or prioritize slices for UEs with critical QoS requirements. These adjustments can be informed by real-time data collected by the distributed units (DUs) and analyzed by AI/ML models hosted on one or more RICs.

In some embodiments, the method 300 can continue, in stage 324, by utilizing AI/ML models (e.g., the AI/ML models hosted on the RICs) to monitor the effectiveness of the applied adaptive radio resource adjustment. In some implementations, the AI/ML models are trained using supervised and unsupervised learning techniques. Data inputs can include historical UE density, movement patterns, SLA compliance metrics, etc. The models can be deployed in real-time to detect anomalies and predict QoS degradation conditions, enabling proactive resource adjustments.

For example, the RICs collect post-adjustment data, including updated network performance metrics and QoS compliance rates, to determine whether the applied changes successfully mitigated the dynamic QoS degradation condition. The AI/ML models can compare this data against historical patterns to refine their predictive capabilities and identify areas for further improvement. Further in stage 324, such embodiments can update the AI/ML models based on the effectiveness of the applied adaptive radio resource adjustment. This updating process may involve retraining the models using new data collected from the network, enabling them to adapt to changing conditions and improve their accuracy over time. For example, if certain beamforming adjustments consistently yield better results in specific scenarios, the models can incorporate this knowledge to make more informed decisions in the future.

In some embodiments, in stage 328, the method 300 can communicate the assigned UNIs to a central database accessible by the core network functions. This centralized repository ensures that all components of the network, including the microcells, DUs, RICs, and core network functions, can access consistent and accurate information about the UEs. The UNIs facilitate seamless coordination between network components, enabling advanced QoS management techniques such as predictive resource allocation and intelligent congestion mitigation.

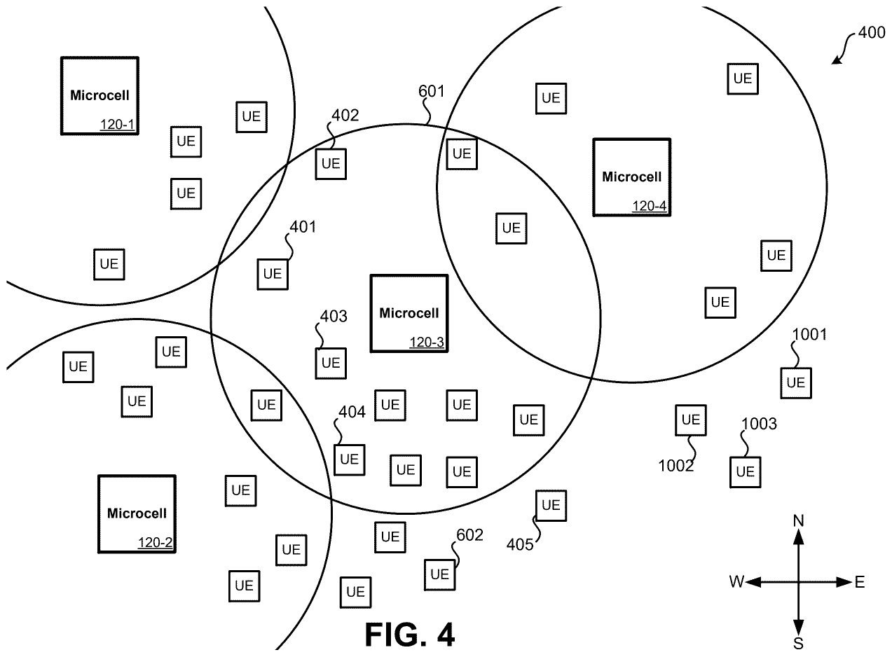

FIG. 4 illustrates a block diagram of an embodiment 400 of multiple cellular microcells providing cellular service to multiple user equipment (UE) in an environment. In embodiment 400, cellular microcells 120 are arranged in an environment to provide cellular network access.

Various UE are present. In some embodiments, in order to access the cellular network through microcells 120, UE may be required to have access to a particular cellular network slice. Even if a UE has a subscription with the same cellular network provider that operates microcells 120, access to one of a particular group of authorized cellular network slices may be necessary. For example, an entity that operates a factory may have a designated slice that only its UE is permitted to use. In other embodiments, all UE permitted to access the cellular network may be permitted to access microcells 120. For example, microcells 120 may be located at a festival, stadium, or shopping mall and are intended to be used by UE operated by members of the public.

As shown in FIG. 4, various UE are present in an environment. In certain geographic regions, the UE are sparse, but in other regions, such as south of microcell 120-3, UE are more closely grouped. Where UE group may be influenced by the time of day and day of week. For instance, in the example of a shopping mall, UE may tend to be located in the food court around lunch time. As another example, UE may tend to congregate in a stadium around 1-4 PM on Sundays. Accordingly, the geographic regions where UE tend to congregate and place strain on the cellular network (e.g., by a large communication load being placed on particular microcells) may tend to repeat and be predictable.

In the example of FIG. 4, the large number of UE being serviced by microcell 120-3 may present a problem. Due to spectrum limitations and backhaul limitations, UE, such as UEs 401-404 may not receive optimal service. More specifically, UEs 401-404 may have been guaranteed particular QoS parameters in accordance with an SLA that may not be able to be met if all of the UE within range 601 are serviced by microcell 120-3.

In FIG. 4, UE may typically be provided service by the microcell with which the UE has the highest signal strength. For example, UE 403 (and other UE located within range 601) may be provided service by microcell 120-3.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for managing quality of service (QOS) in a microcell network comprising a plurality of collocated microcells, the method comprising:
detecting, by the microcell network, a plurality of user equipment (UEs) in communication with the microcell network;
assigning a unified network identifier (UNI) to each of the plurality of UEs;
detecting a dynamic QoS degradation condition based on monitoring behavior of the plurality of UEs using the UNIs to detect one or more variations in UE dynamics predicted to violate one or more QoS parameters defined in service level agreements (SLAs) associated with the plurality of UEs;
coordinating with core network functions to determine an adaptive radio resource adjustment to mitigate the dynamic QoS degradation condition; and
applying the adaptive radio resource adjustment to at least one of the plurality of microcells.

2. The method of claim 1, wherein detecting the dynamic QoS degradation condition comprises utilizing artificial intelligence and/or machine learning (AI/ML) models hosted on Radio Access Network (RAN) Intelligent Controllers (RICs) of the microcell network to analyze real-time data collected from the plurality of UEs.

3. The method of claim 2, wherein the RICs on which the AI/ML models are hosted are implemented within the plurality of microcells.

4. The method of claim 2, wherein the AI/ML models are trained to detect the one or more variations in UE dynamics by recognizing patterns in at least one of UE density, UE movement patterns, or UE data usage.

5. The method of claim 2, further comprising:
monitoring, by the AI/ML models, an effectiveness of the applied adaptive radio resource adjustment for mitigating the dynamic QoS degradation condition; and
updating the AI/ML models based on the effectiveness of the applied adaptive radio resource adjustment.

6. The method of claim 1, wherein assigning the UNI to each UE of the plurality of UEs comprises generating the UNI based on at least one standardized identifier used by at least one of the core network functions to identify the UE in the network.

7. The method of claim 1, wherein coordinating with core network functions comprises communicating with at least one of a network repository function (NRF), a network slice selection function (NSSF), a policy control function (PCF), or an access and mobility management function (AMF) to determine the adaptive radio resource adjustment.

8. The method of claim 1, wherein applying the adaptive radio resource adjustment comprises adjusting beamforming and/or beam steering parameters to direct radio frequency energy toward areas with higher UE density.

9. The method of claim 1, wherein applying the adaptive radio resource adjustment comprises adjusting scheduling priorities to prioritize network resources for UEs or UE categories with higher QoS requirements as per their SLAs.

10. The method of claim 1, wherein applying the adaptive radio resource adjustment comprises adjusting transmission power levels of at least one microcell.

11. The method of claim 1, wherein the one or more variations in UE dynamics is detected at an individual UE level.

12. The method of claim 1, wherein:
assigning the UNI to each of the plurality of UEs includes associating each of the plurality of UEs with a UE category; and
the one or more variations in UE dynamics is detected at a UE category level.

13. The method of claim 1, further comprising, subsequent to assigning the UNI to each of the plurality of UEs:
communicating the UNIs to a central database accessible by the core network functions.

14. A microcell network system comprising:
a collocated plurality of microcells; and
one or more radio access network (RAN) intelligent controllers (RICs) configured to:
assign a unified network identifier (UNI) to each of a plurality of user equipment (UEs) in communication with the plurality of microcells;
detect, using artificial intelligence and/or machine learning (AI/ML) models hosted by the one or more RICs, a dynamic quality-of-service (QOS) degradation condition based on monitoring behavior of the plurality of UEs using the UNIs to detect one or more variations in UE dynamics predicted to violate one or more QoS parameters defined in service level agreements (SLAs) associated with the plurality of UEs;
coordinate with core network functions to determine an adaptive radio resource adjustment to mitigate the dynamic QoS degradation condition; and
apply the adaptive radio resource adjustment to at least one of the plurality of microcells.

15. The microcell network system of claim 14, wherein:
the plurality of microcells is configured to communicate with the plurality of UEs using a cellular communication protocol and to communicate with a cellular core network comprising the core network functions.

16. The microcell network system of claim 14, wherein the one or more RICs on which the AI/ML models are hosted is implemented within one or more of the plurality of microcells.

17. The microcell network system of claim 14, wherein the one or more variations in UE dynamics is detected at an individual UE level.

18. The microcell network system of claim 14, wherein:
assigning the UNI to each of the plurality of UEs includes associating each of the plurality of UEs with a UE category; and
the one or more variations in UE dynamics is detected at a UE category level.

19. The microcell network system of claim 14, wherein the AI/ML models are trained to detect the one or more variations in UE dynamics by recognizing patterns in at least one of UE density, UE movement patterns, or UE data usage.

20. The microcell network system of claim 14, wherein applying the adaptive radio resource adjustment comprises one or more of: adjusting beamforming and/or beam steering parameters to direct radio frequency energy toward areas with higher UE density; adjusting scheduling priorities to prioritize network resources for UEs or UE categories with higher QoS requirements as per their SLAs; or adjusting transmission power levels of at least one microcell.
